(19) United States
(12) Patent Application Publication
(10) Pub. No.: US 2013/0166732 A1
(43) Pub. Date: Jun. 27, 2013

(54) CLIENT MANAGING SYSTEM, CLIENT MANAGING METHOD, AND INFORMATION PROCESSING APPARATUS

(71) Applicant: Atsushi Asayama, Suginami-ku (JP)

(72) Inventor: Atsushi Asayama, Suginami-ku (JP)

(21) Appl. No.: 13/543,066

(22) Filed: Jul. 6, 2012

(30) Foreign Application Priority Data
Dec. 27, 2011 (JP) 2011-287020

(51) Int. Cl. G06F 15/173

(52) U.S. Cl. 709/224

(57) ABSTRACT

In one embodiment, there is provided a client managing system including: a server; a client connected to the server via the Internet. The server includes: a generator configured to generate a policy data for the client; a first storage configured to store the policy data; a delivering module configured to deliver the policy data to the client; and a second storage configured to store a first index data therein, wherein the first index data corresponds to a first log data representing contents of operations performed on the client. The client includes: a sender configured to: i) generate a second log data representing contents of operations performed on the client; ii) send the second log data to a file storage connected to the client via a network; iii) generate a second index data corresponding to the second log data; and iv) send the second index data to the server.

This application claims priority from Japanese Patent Application No. 2011-287020, filed on Dec. 27, 2011, the entire contents of which are hereby incorporated by reference.

### BACKGROUND

1. Field

Embodiments described herein relate to a client managing system, a client managing method, and an information processing apparatus.

2. Description of the Related Art

In client-server systems in which each client and a server are connected to each other, log data as records of processing and operations performed in each client may be managed by the server. For example, the server can cope with trouble that has occurred in the system by detecting an illegal operation made in a client by searching the log data of the respective client.

In general, a server and each of plural clients are connected to each other. While the plural clients are used, log data of the plural clients are accumulated in the server.

When it is necessary to find log data having a particular character string in accumulated log data, the server searches the accumulated log data by an index method, for example. In the index method, indices corresponding to respective log data are generated in advance. Log data can be searched at high speed by using their indices, and hence necessary log data can be found quickly in accumulated log data.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a conceptual diagram of a public cloud-based client managing system according to the embodiment;

FIG. 2 is a block diagram showing an example configuration of a management server (public cloud) of the client managing system according to the embodiment;

FIG. 3 is a block diagram showing an example configuration of each client of the client managing system according to the embodiment;

FIG. 4 shows an example operation log data saving setting screen which is displayed by the client managing system according to the embodiment;

FIG. 5 shows an example policy setting screen which is displayed by the client managing system according to the embodiment;

FIG. 6 shows example temporary operation log data which is used by the client managing system according to the embodiment;

FIG. 7 shows example operation log data of respective log types (functions) which are used by the client managing system according to the embodiment;

FIG. 8 shows example file index data which is included in temporary index data used by the client managing system according to the embodiment;

FIG. 9 shows example word index data which are included in the temporary index data used by the client managing system according to the embodiment;

FIG. 10 shows an example picture which is used for an operation log data search in the client managing system according to the embodiment;

FIG. 11 shows example word index data to be referred to in searching operation log data in the client managing system according to the embodiment;

FIG. 12 shows example file index data to be referred to in searching the operation log data in the client managing system according to the embodiment;

FIG. 13 shows search temporary result information which is used in the client managing system according to the embodiment;

FIG. 14 shows search result information which is used in the client managing system according to the embodiment;

FIG. 15 shows a first part of an example operation log data managing process which is executed by the client managing system according to the embodiment;

FIG. 16 shows a second part of the example operation log data managing process which is executed by the client managing system according to the embodiment;

FIG. 17 shows an example system configuration of the management server of the client managing system according to the embodiment; and

FIG. 18 shows an example system configuration of each client of the client managing system according to the embodiment.

### DETAILED DESCRIPTION

According to exemplary embodiments of the present invention, there is provided a client managing system. The client managing system includes: a server; a client connected to the server via the Internet. The server includes: a generator configured to generate a policy data for the client; a first storage configured to store the policy data therein; a delivering module configured to deliver the policy data to the client; and a second storage configured to store a first index data therein, wherein the first index data corresponds to a first log data representing contents of operations performed on the client. The client includes: a sender configured to: i) generate a second log data representing contents of operations performed on the client; ii) send the second log data to a file storage connected to the client via a network; iii) generate a second index data corresponding to the second log data based on the second log data; and iv) send the second index data to the server.

An embodiment of the present invention will be hereinafter described with reference to the drawings.

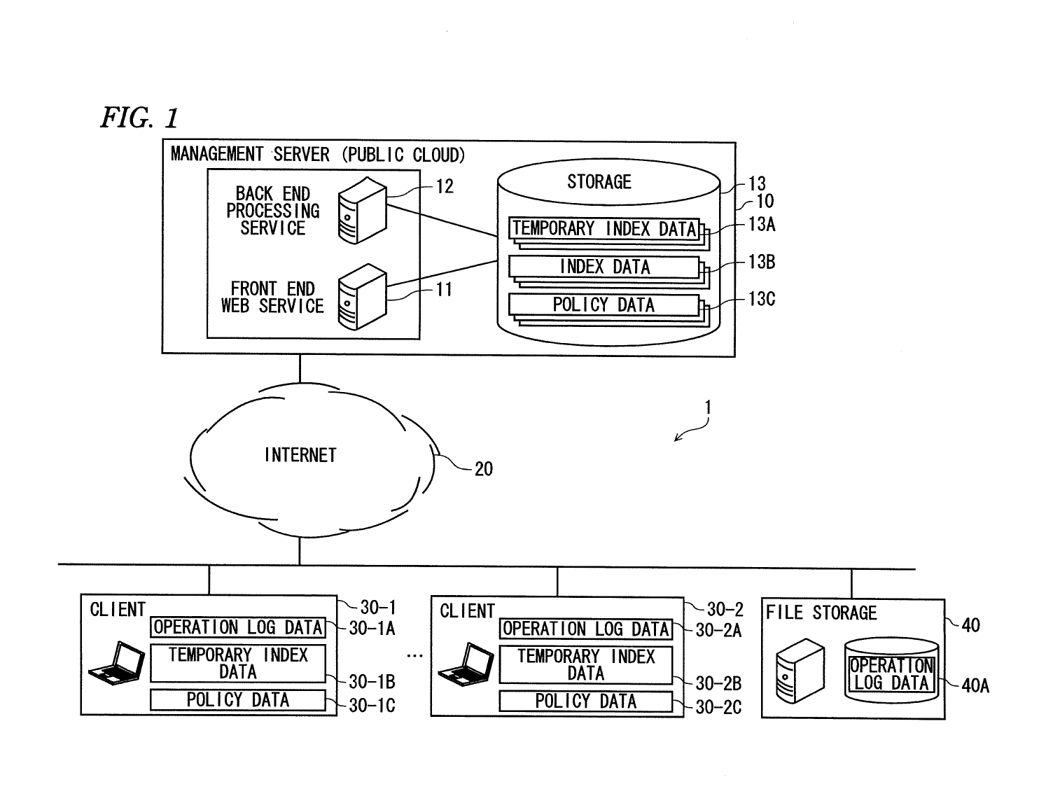

FIG. 1 is a conceptual diagram of a public cloud-based client managing system 1 according to the embodiment. In the client managing system 1, a management server (public cloud) 10 and each of (one or more) clients 30-1 and 30-2 and a file storage 40 are connected to each other via the Internet. And the clients 30-1 and 30-2 and the file storage 40 are connected to each other via a network such as a local area network.

In the client managing system 1, operation log data 30-1A and 30-2A are stored in the file storage 40 in a concentrated manner. Furthermore, in the client managing system 1, temporary index data 30-1B and 30-2B are stored in a storage 13 of the management server 10 in a concentrated manner.

More specifically, the clients 30-1 and 30-2 generate operation log data 30-1A and 30-2A indicating operations performed on the clients 30-1 and 30-2, and sends the generated operation log data 30-1A and 30-2A to the file storage 40 over the network such as a local area network. The management server 10 stores, in the storage 13, temporary index data 30-1B and 30-2B that are transmitted from the clients 30-1 and 30-2. Other data shown in FIG. 1 will be described later with reference to other drawings.

In the client managing system 1 according to the embodiment, the clients 30-1 and 30-2 generate temporary index data 30-1B and 30-2B corresponding to respective operation log data 30-1A and 30-2A in advance and the management server 10 merges the generated and transmitted temporary index data 13A with index data 13B.

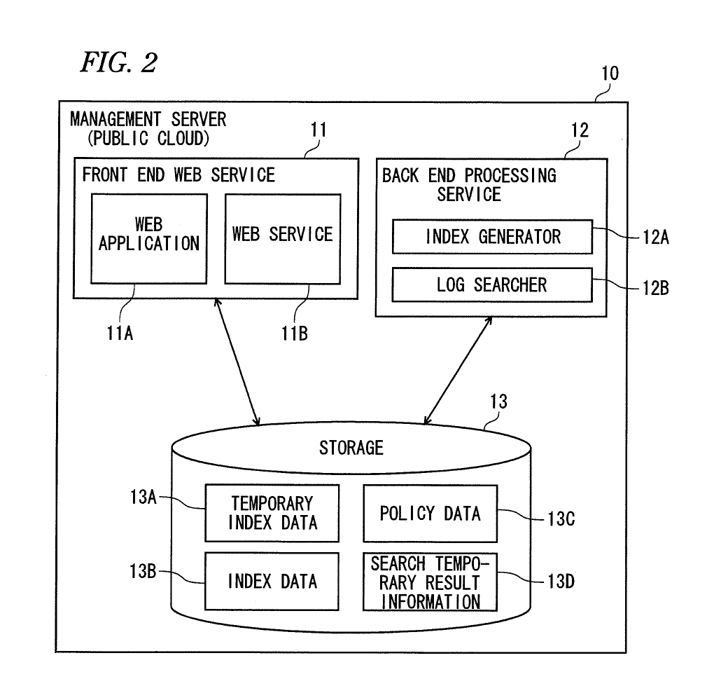

FIG. 2 shows an example configuration of the management server (public cloud) 10 of the client managing system 1 according to the embodiment.

The management server 10 includes a front end web service 11, a back end processing service 12, and the storage 13. Whereas the example of FIG. 1 is such that the front end web service 11 and the back end processing service 12 are executed on different computers, the following description will be made with an assumption that they are executed on the same computer.

The front end web service 11 includes a web application 11A and a web service 11B. The web application 11A is an application of such a type as to be used over a network through a web browser or the like without installing a program in a client computer. The web service 11B is a service that is executed on the Web and that receives HTTP request information including a query from a user, performs computation etc. using the received query, and provides a web page showing a processing result.

The back end processing service 12 includes an index generator 12A and a log searcher 12B. The index generator 12A merges temporary index data 13A stored in the storage 13 with index data 13B stored in the storage 13. The log searcher 12B acquires search temporary result information 13D (search keyword, search conditions, and file path) that satisfies the received search conditions and stores the acquired search temporary result information 13D in the storage 13.

Temporary index data 13A, index data 13B, policy data 13C, and search temporary result information 13D are stored in the storage 13.

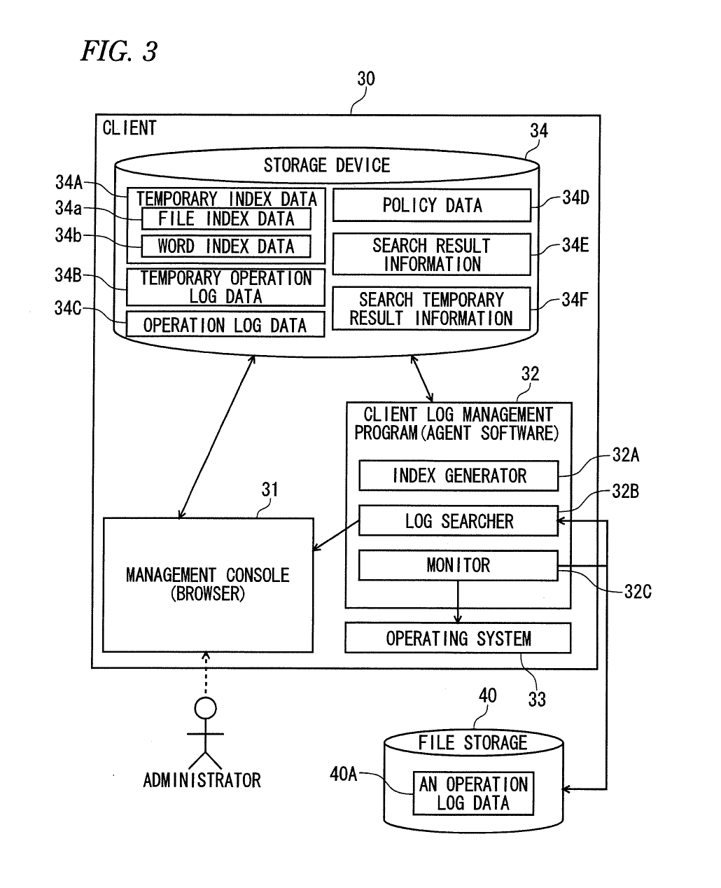

Temporary index data 34A that is generated by each client 30 (described later with reference to FIG. 3) is transmitted to the management server 10 as temporary index data 13A through the web service 11B on a regular basis (e.g., once an hour)

Index data 13B is merged with temporary index data 13A by the index generator 12A with such timing that, for example, the temporary index data 13A is transmitted from each client 30. Temporary index data 13A is deleted when it is merged with index data 13B.

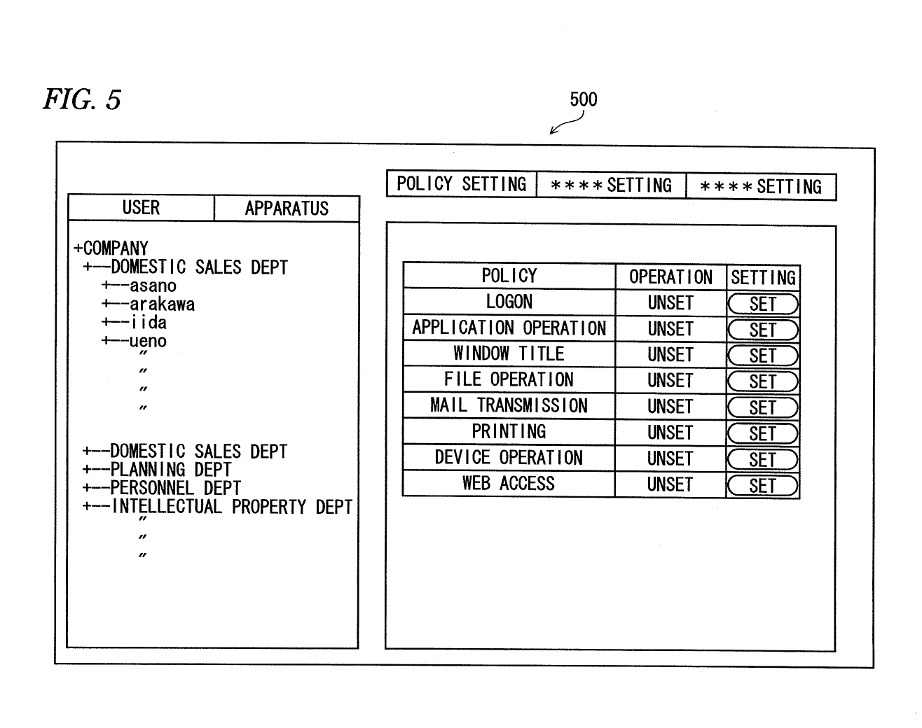

Policy data 13C shows what kinds of operation log data are collected for each user. More specifically, as shown in FIG. 5, each policy data 13C shows setting statuses of respective items such as logon, application operation, window title, file operation, mail transmission, printing, device operation, and web access. When generated, policy data 13C is delivered to a storage device 34 of a corresponding client 30 through the web service 11B. Policy data 13C may be generated for each user, each client (computer) 30, or each group of plural users (or plural clients 30).

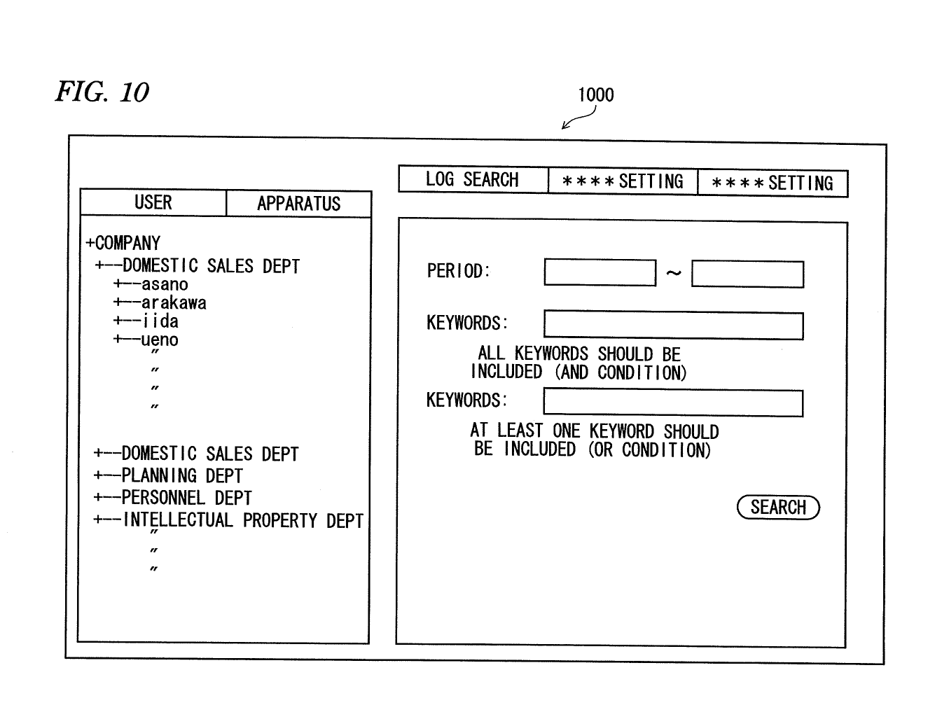

The search temporary result information 13D is information that indicates conditions to be used for reading out one or some, satisfying search conditions that have been input to a search screen 1000 shown in FIG. 10, of the operation log data 40A stored in the file storage 40.

FIG. 3 shows an example configuration of each client 30 of the client managing system 1 according to the embodiment.

Each client 30 includes a management console (browser) 31, a client log management program (agent software) 32, an operating system 33, and a storage device 34.

In response to a user (manager) operation, the management console 31 generates and displays policy data and displays an operation log data search result according to a prescribed operation. The generated policy data is delivered to the storage device 34 of a corresponding client 30 through the web service 11B shown in FIG. 2.

The client log management program 32 includes an index generator 32A, a log searcher 32B, and a monitor 32C.

The index generator 32A generates temporary index data 34A corresponding to temporary log data generated by the monitor 32C on a regular basis (e.g., once an hour) and stores the generated temporary index data 34A in the storage device 34 on a regular basis (e.g., once an hour). Furthermore, the index generator 32A generates operation log data 34C (40A) for respective log types (functions) on the basis of the temporary operation log data 34B and stores the generated operation log data 34C (40A) in the storage device 34 and the file storage 40. Stored temporary index data 34A is sent to the storage 13 of the management server 10 through the web service 11B shown in FIG. 2 on a regular basis (e.g., once an hour). The temporary index data 34A stored so far is deleted.

The log searcher 32B reads out search keywords, a search condition type, and a file path that are contained in search temporary result information 34F stored in the storage device 34, and acquires search result information 34E from a log file that is read out according to the read-out file path.

The monitor 32C detects operations performed on the client 30 by monitoring the operating system 33, various application programs that are run on the client 30. For example, the monitor 32C detects operations relating to logon, application operation, window title, file operation, mail transmission, printing, device operation, web access, etc. For example, the monitor 32C may detect, in addition to user operations, operations (e.g., an inquiry made of a mail server every prescribed time or regular update of a security program) of programs that are run automatically every prescribed time. The monitor 32C stores detection results of operations on the client 30 in the storage device 34 as temporary operation log data 34B.

Temporary index data 34A, temporary operation log data 34B, operation log data 34C, policy data 34D, search result information 34E, and search temporary result information 34F are stored in the storage device 34.

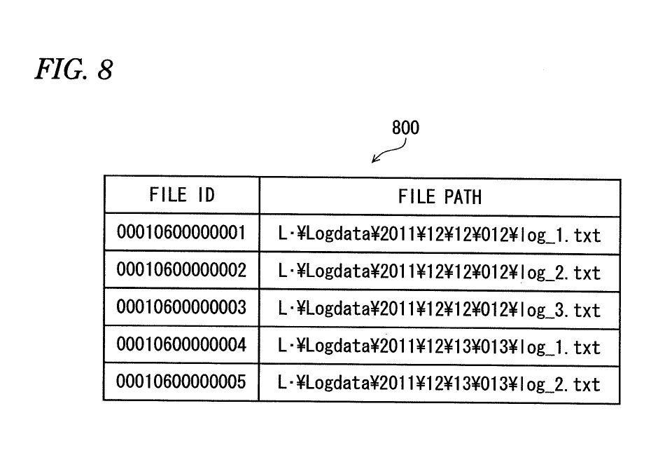

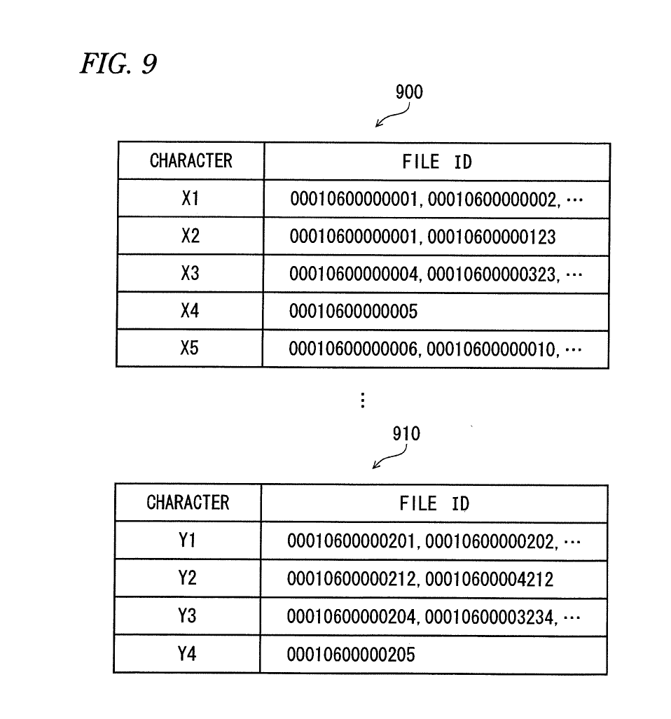

The temporary index data 34A includes file index data 34a and word index data 34b. The file index data 34a and the word index data 34b will be described later with reference to FIGS. 8 and 9.

When a prescribed operation on the client 30 is detected by the monitor 32C, the content of the operation is described in a prescribed format as temporary operation log data 34B and the temporary operation log data 34B is stored in the storage device 34.

Operation log data 34C are generated regularly (e.g., once per hour) for respective log types (functions) on the basis of the temporary operation log data 34B, and stored in the storage device 34.

The policy data 34D is stored in the storage device 34 in such a manner that log types (functions) that have been set through a policy setting screen 500 shown in FIG. 5 are correlated with the client 30.

The search result information 34E is information indicating one or some, satisfying the search conditions that have been input to the search screen 1000 shown in FIG. 10, of the operation log data 40A stored in the file storage 40.

The search temporary result information 34F is information indicating conditions to be used for reading out one or some, satisfying the search conditions that have been input to the search screen 1000 shown in FIG. 10, of the operation log data 40A stored in the file storage 40.

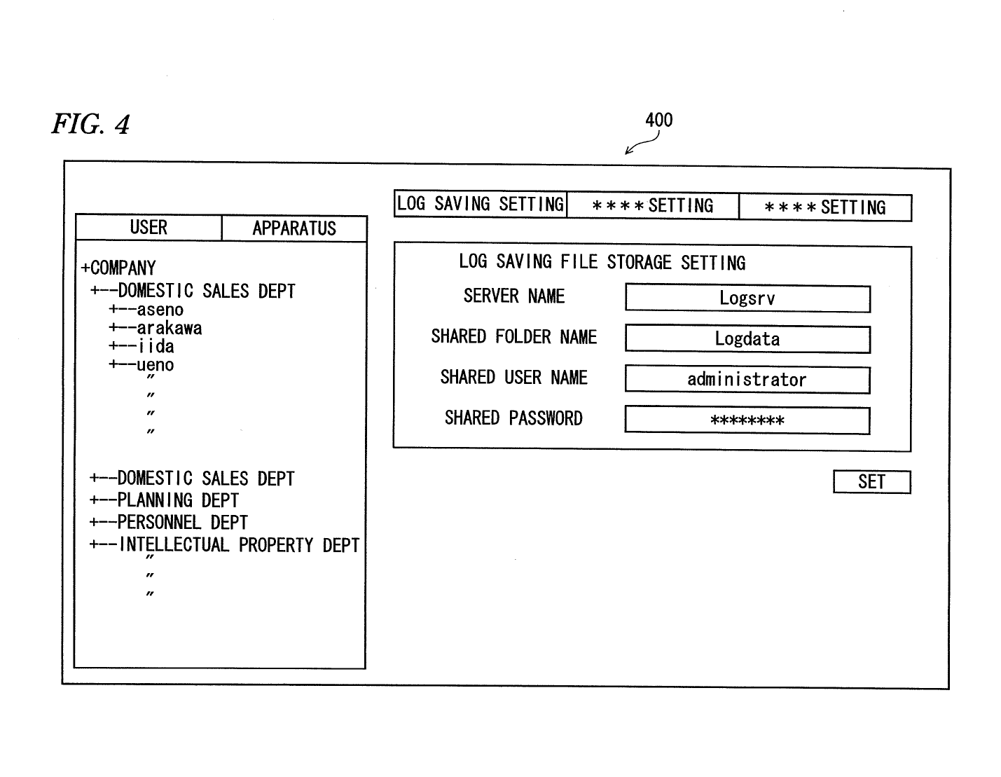

FIG. 4 shows an example of a setting screen 400 for saving operation log data which is displayed by the client managing system 1 according to the embodiment. A saving destination of operation log data can be set by inputting the name of a server to store the operation log data, the name of a shared folder to store the operation log data, etc. to input boxes of the setting screen 400 and depressing a Set button.

FIG. 5 shows an example policy setting screen 500 which is displayed by the client managing system 1 according to the embodiment.

As shown in FIG. 5, whether to detect operations such as web access, file operation, device operation, and logon is set through the policy setting screen 500. Policy data 13C is generated by the web application 11A of the management server 10 according to whether individual policy items are set through the management console (browser) 31 of a client 30. As mentioned above, policy data 13C may be generated for each user, each client (computer) 30, or each group of plural users (or plural clients 30).

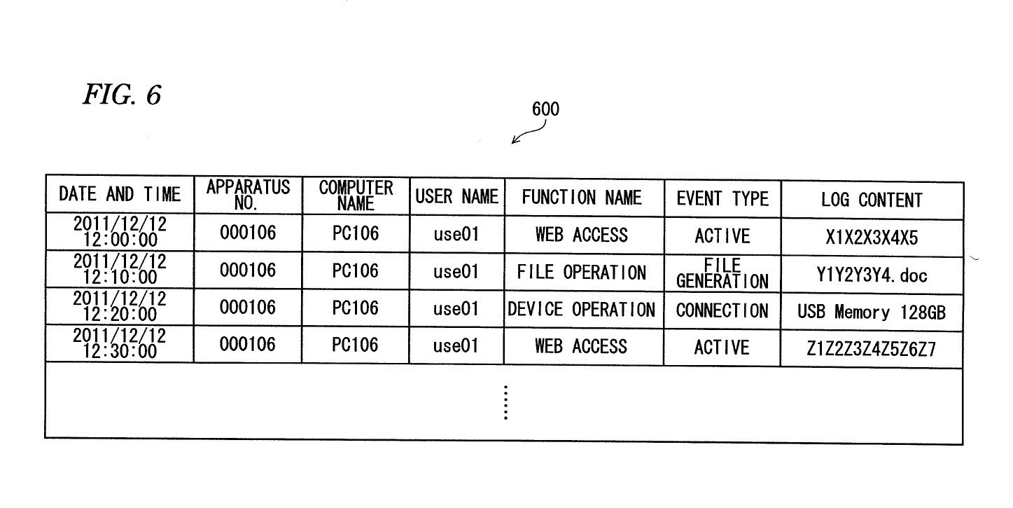

FIG. 6 shows example temporary operation log data 600 which is used by the client managing system 1 according to the embodiment. Temporary operation log data 600 (temporary operation log data 34B shown in FIG. 3) is generated for each client 30. The temporary operation log data 600 shown in FIG. 6 is data generated by apparatus 000106 (PC 106). Each entry of the temporary operation log data 600 includes a date and time, an apparatus number, a computer name, a user name, a function name (log type), an event type, and a log content.

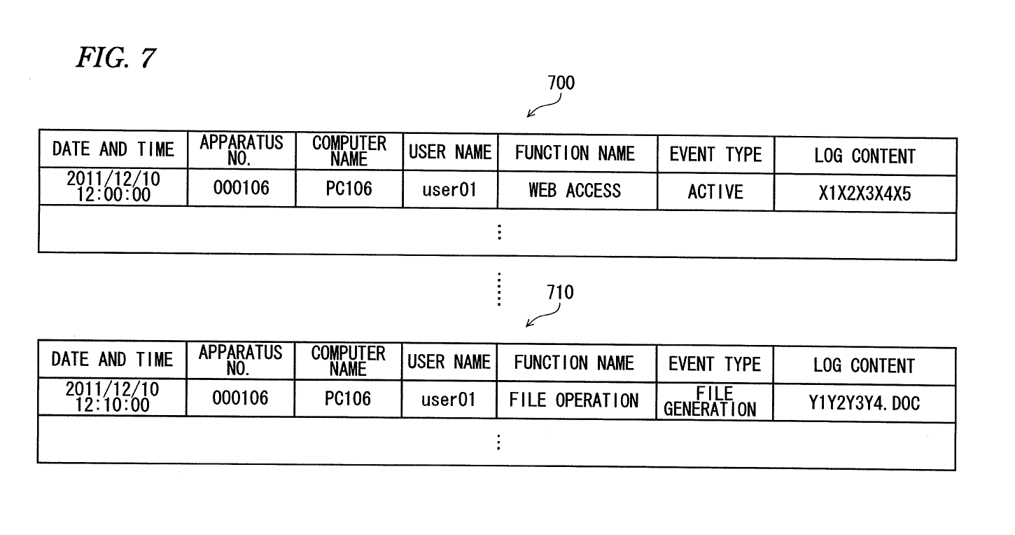

FIG. 7 shows example operation log data 700 and 710 of respective log types (functions) which are used by the client managing system 1 according to the embodiment. For example, the operation log data 700 includes entries, having the log type (function) “web access,” of the temporary operation log data 600 shown in FIG. 6. Likewise, the operation log data 710 includes entries, having the log type (function) “file operation,” of the temporary operation log data 600 shown in FIG. 6.

FIG. 8 shows example file index data 800 (file index data 34a shown in FIG. 3) which is included in the temporary index data 34A used by the client managing system 1 according to the embodiment.

The file index data 800 includes plural entries corresponding to plural respective log files. For example, when plural operation log data 34C (plural log files) are stored in the storage device 34, the file index data 34a includes plural entries like the file index data 800. For example, each entry includes a file ID and a file path. In an entry corresponding to a certain log file, the “file ID” is identification information that is unique to the log file. For example, the value that is set as a file ID is a value obtained by adding, as a suffix, a sequential number assigned to the log file to the apparatus number of a client 30 or a base ID (client ID) that was transmitted from the management server 10 in advance. For example, when a new log file which is assigned a sequential number “00000001” is generated in a client 30 having an apparatus number “000106,” a value “00010600000001” is set as the file ID of the entry corresponding to the log file.

The “file path” represents a file path that indicates a location in the file storage 40 where the log file is stored. Each client 30 generates a file path value by adding, as a suffix, the file name of a log file to a path representing predetermined directories. For example, a new log file which is assigned a file name “log_{—}3.txt” is generated in the case where the predetermined directories are “L:¥Logdata¥2011¥12¥12¥012,” a value “L:¥Logdata¥2011¥12¥12¥012¥log_{—}3.txt” is set as the file path of the entry corresponding to the log file.

FIG. 9 shows example word index data 900 and 910 (word index data 34b shown in FIG. 3) which are included in the temporary index data 34A used by the client managing system 1 according to the embodiment. It is assumed that the word index data 900 and 910 are generated according to a unigram model (i.e., an n-gram model in which n is equal to 1).

Each of the word index data 900 and 910 includes plural entries corresponding to plural respective characters. Each entry includes a character and a file ID. In an entry corresponding to a certain character, the item “character” represents the character itself and “file IDs” is the ID of a log file containing the character. The IDs of plural log files may be set as “file IDs.” Each of the word index data 900 and 910 includes entries corresponding to all characters that are included in the log contents of the corresponding operation log data 34C (log file).

For example, the word index data 900 is a word index data of a case that the log type (function) is “web access.” The word index data 910 is a word index data of a case that the log type (function) is “file operation.”

More specifically, as shown in FIG. 9, where the log content of a log file having a file ID “00010600000001” includes a character string “X1X2,” “00010600000001” is set as an element of the “file IDs” of the entry corresponding to the character “X1” and an element of the “file IDs” of the entry corresponding to the character “X2.” Therefore, it is known by referring to the word index data 34b that, for example, log files having respective file IDs “00010600000001” and “00010600000123” include the character “X2.”

The word index data 34b generated are not limited to word index data corresponding to characters obtained by an n-gram model and may be word index data corresponding to words obtained by a morphological analysis.

FIG. 10 shows an example screen 1000 which is used for an operation log data search in the client managing system 1 according to the embodiment. The screen 1000 is displayed on the management console (browser) 31.

As shown in FIG. 10, conditions for searching the operation log data are, for example, a period, keywords all of which should be included (AND condition), and keywords at least one of which should be included (OR condition). The operation log data 40A are searched by inputting those conditions and then depressing a Search button.

An example search will be described below that is performed when “X1X2” and “X3X4X5” are input to the input box for keywords all of which should be included and then the Search button is depressed.

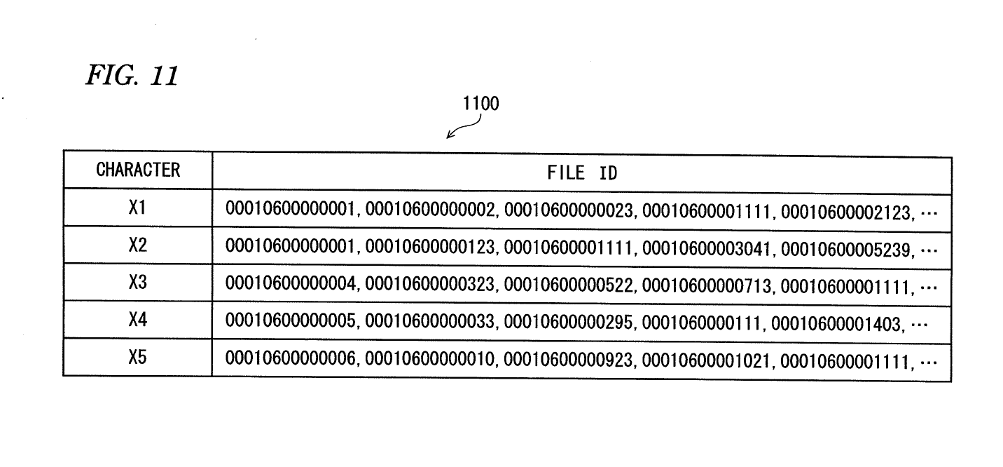

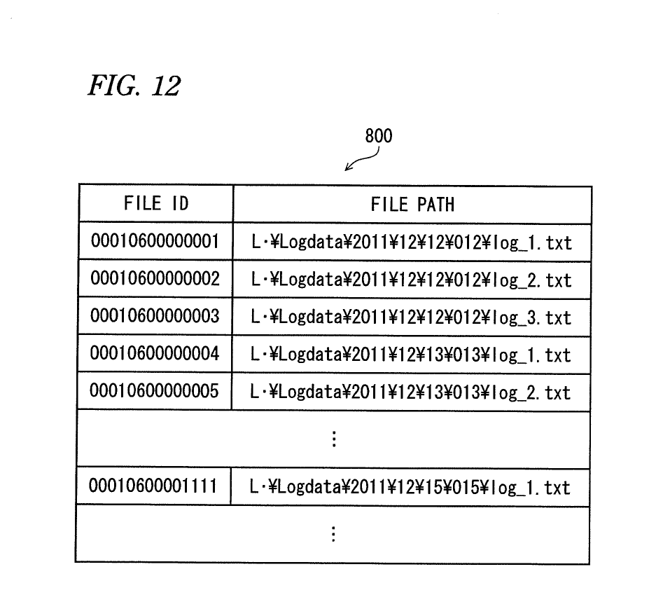

It is assumed that the operation log data 40A are searched using word index data 1100 shown in FIG. 11 and keywords “X1X2” and “X3X4X5.” In this case, when the Search button is depressed, first, the log searcher 12B of the management server 10 decomposes the keywords and detects characters “X1,” “X2,” “X3,” “X4,” and “X5”. Then, the log searcher 12B detects file IDs corresponding to the respective characters using the word index data 1100. More specifically, the log searcher 12B detects file IDs “00010600000001,” “00010600000002,” “00010600000023,” “00010600001111,” and “00010600002123” for the character “X1”. Likewise, the log searcher 12B detects file IDs for each of the characters “X2”, “X3”, “X4”, and “X5”. Then, the log searcher 12B detects a file ID(s) that corresponds to all the characters among the sets of file IDs corresponding to the respective characters. More specifically, the file ID “00010600001111” which corresponds to all the characters “X1”, “X2”, “X3”, “X4”, and “X5”. That is, the log searcher 12B detects the file ID of a log file(s) including all the characters included in the keywords. Then, the log searcher 12B detects a file path corresponding to the detected file ID using file index data 800 shown in FIG. 12.

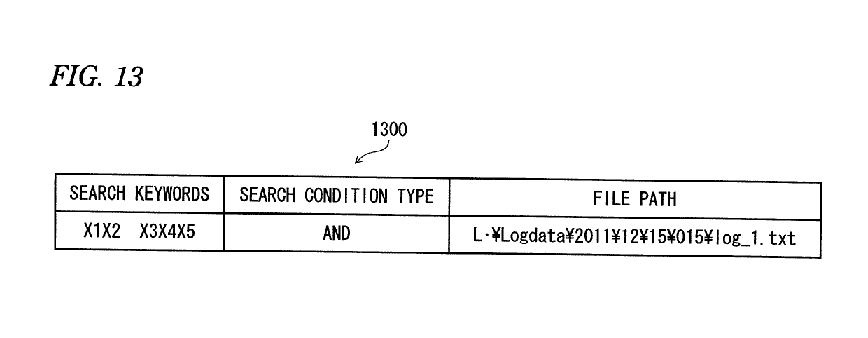

Then, the log searcher 12B stores the search keywords, the search condition type, and the file path (i.e., search temporary result information 1300 (search temporary result information 13D shown in FIG. 2)) in the storage 13 in the manner shown in FIG. 13. Furthermore, the log searcher 12B sends the search temporary result information 1300 to the client 30 through the web service 11B and causes it to be stored in the storage device 34 as search temporary result information 34F.

The log searcher 32B of the client 30 reads out the search keywords, the search condition type, and the file path that are contained in the search temporary result information 34F stored in the storage device 34.

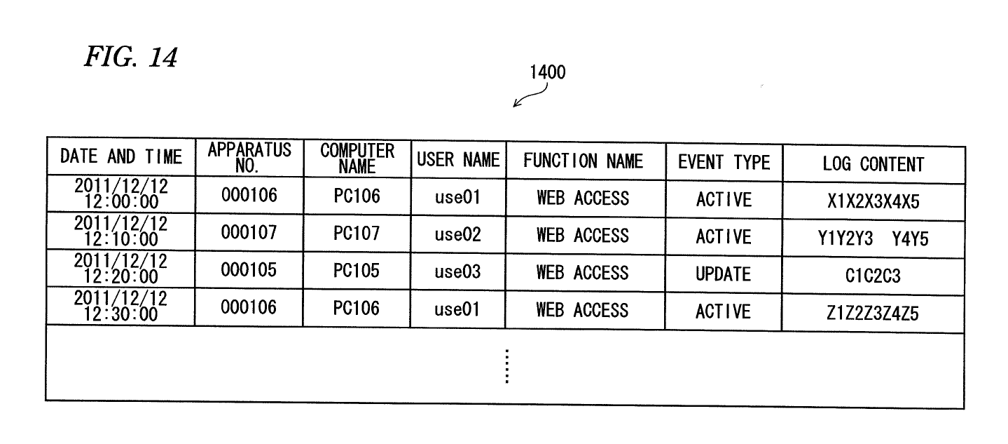

Then, the log searcher 32B mounts the shared folder, stored with the operation log data 40A, of the file storage 40. Then, the log searcher 32B finds information that satisfies the keywords and the search condition type (i.e., “X1X2” and “X3X4X5”) in the log file that is read out on the basis of the file path contained in the search temporary result information 34F, and stores the information in the storage device 34 of the client 30 as search result information 34E. Furthermore, the log searcher 32B causes the search result information 34E on the management console (browser) 31 in the manner shown in FIG. 14.

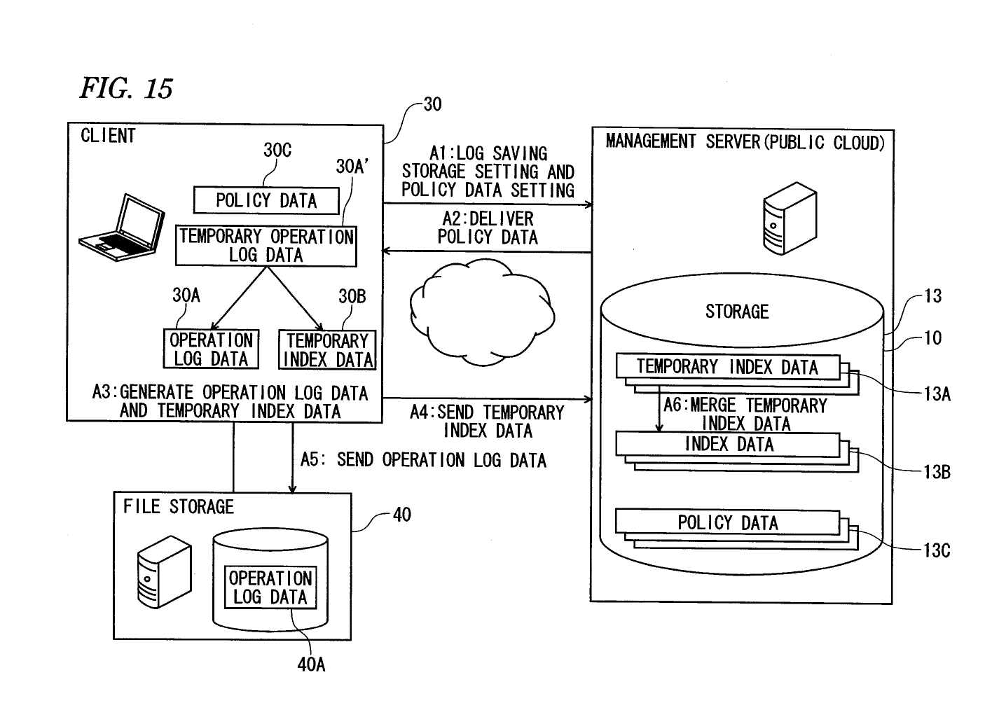

FIG. 15 shows a first part of an example operation log data managing process which is executed by the client managing system 1 according to the embodiment.

First, at step A1, a user (manager) makes file storage setting for log saving (see FIG. 4) and policy data setting (see FIG. 5) through the management console (browser) of a client 30.

At step A2, the management server (public cloud) 10 delivers the thus-set policy data 13C to the client 30 that is correlated with the policy data 13C.

At step A3, the client 30 generates temporary log data 30A′ according to the delivered policy data 30C, and generates operation log data 30A and temporary index data 30B of respective log types (functions) on the basis of the temporary log data 30A′ on a regular basis (e.g., once an hour).

At step A4, the client 30 sends the generated temporary index data 30B to the management server 10 regularly (e.g., once an hour). At step A5, the client 30 sends the generated operation log data 30A to the file storage 40 regularly (e.g., once an hour).

At step A6, the management server 10 merges the transmitted temporary index data 13A with index data 13B.

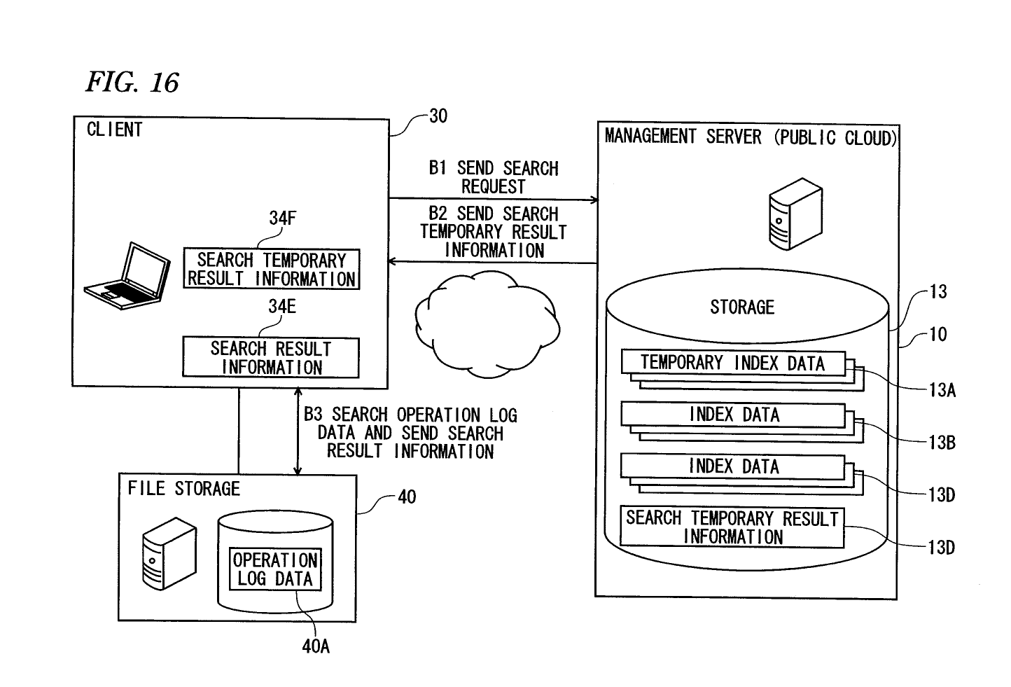

FIG. 16 shows a second part of an example operation log data managing process which is executed by the client managing system 1 according to the embodiment.

First, at step B1, the user (manager) inputs search conditions (see FIG. 10) through the management console (browser) 31 of the client 30 and sends a search request to the management server (public cloud) 10.

At step B2, the management server 10 generates search temporary result information 13D on the basis of the search conditions and sends the generated search temporary result information 13D to the client 30.

At step B3, the client 30 searches the operation log data 40A stored in the file storage 40 according to the transmitted search temporary result information 34F, generates search result information 34E, and displays the generated search result information 34E on the management console 31.

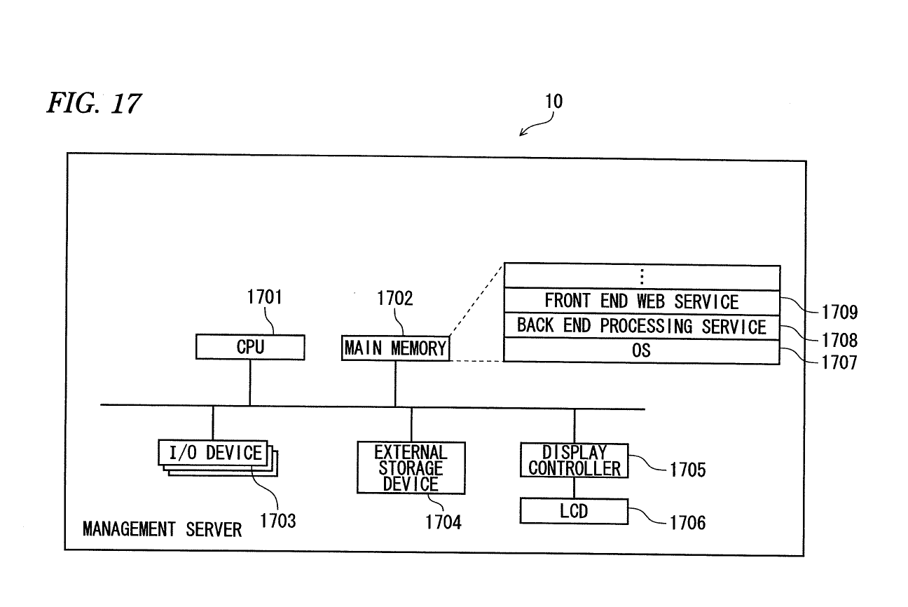

FIG. 17 shows an example system configuration of the management server 10. The management server 10 is equipped with a CPU (central processing unit) 1701, a main memory 1702, I/O devices 1703, an external storage device 1704, a display controller 1705, an LCD (liquid crystal display) 1706, etc.

The CPU 1701 is a processor which runs various programs. The CPU 1701 performs various kinds of computation and controls the individual components of the management server 10.

The main memory 1702 is a memory for storing various programs such as an operating system (OS) 1707, a back end processing service 1708, and a front end web service 1709 and various data. For example, the OS 1707, the back end processing service 1708, and the front end web service 1709 are loaded in the main memory 1702.

The I/O devices 1703 are various input/output devices for input and output of data to and from the management server 10. The external storage device 1704 is a nonvolatile storage device for storing various programs and data. (Part of) the various programs and data stored in the external storage device 1704 are loaded into the main memory 1702 in response to a request from an individual component of the management server 10.

The display controller 1705 controls the LCD 1706 which is used as a display monitor of the management server 10. A display signal generated by the display controller 1705 is supplied to the LCD 1706.

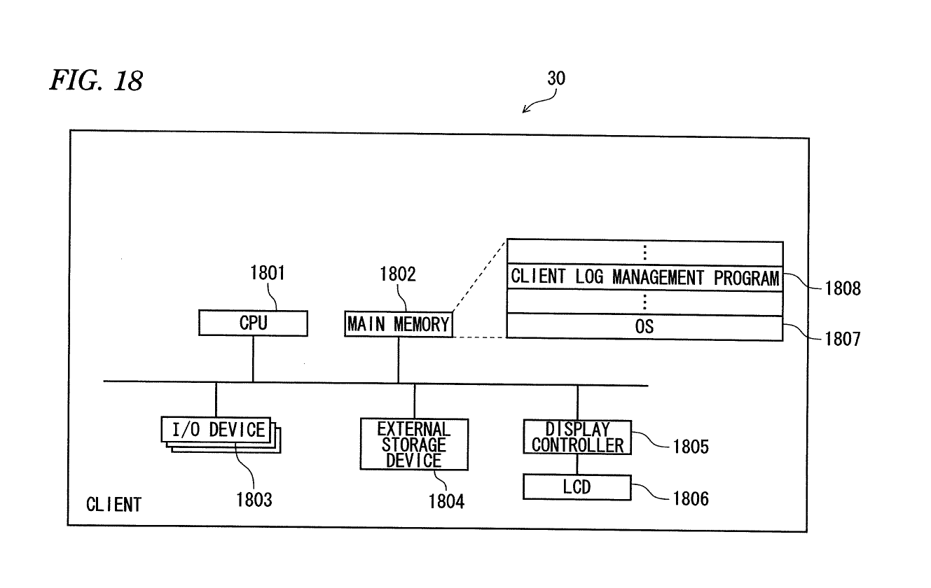

FIG. 18 shows an example system configuration of each client 30. Each client 30 is equipped with a CPU (central processing unit) 1801, a main memory 1802, I/O devices 1803, an external storage device 1804, a display controller 1805, an LCD (liquid crystal display) 1806, etc.

The CPU 1801 is a processor which runs various programs. The CPU 1801 performs various kinds of computation and controls the individual components of the client 30.

The main memory 1802 is a memory for storing various programs such as an operating system (OS) 1807 and a client log management program 1808 and various data. For example, the OS 1807 and the client log management program 1808 are loaded in the main memory 1802.

The I/O devices 1803 are various input/output devices for input and output of data to and from the client 30. The external storage device 1804 is a nonvolatile storage device for storing various programs and data. (Part of) the various programs and data stored in the external storage device 1804 are loaded into the main memory 1802 in response to a request from an individual component of the client 30.

The display controller 1805 controls the LCD 1806 which is used as a display monitor of the client 30. A display signal generated by the display controller 1805 is supplied to the LCD 1806.

As described above, in the public cloud-based client managing system 1 according to the embodiment, index data are stored in the public cloud and operation log data are stored locally. Therefore, such security-related anxiety as caused because a location of logs is unknown can be reduced. Furthermore, since data stored in the public cloud or locally are controlled according to policy data, loads on the entire system can be adjusted and data can be distributed in an optimum manner.

In the embodiment, the server log managing process and the client log management process can both be executed by software. Therefore, the same advantages as provided by the embodiment can be provided easily by installing programs for executing the server log managing process and the client log management process in ordinary computers via a computer-readable storage medium that is stored with those programs.

For example, the embodiment may be modified so that operation log data of particular log types (e.g., main transmission) which may contain secret information are managed by the file storage and operation log data of the other log types are managed by the storage of the public cloud.

Furthermore, the embodiment may be modified so that operation log data of such log types (e.g., file operation monitoring) as to have large sizes are managed by the file storage and operation log data of the other log types are managed by the storage of the public cloud.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A client managing system comprising:
a server;
a client connected to the server via the Internet,
wherein the server comprises:
a generator configured to generate a policy data for the client;
a first storage configured to store the policy data therein;
a delivering module configured to deliver the policy data to the client; and
a second storage configured to store a first index data therein, wherein the first index data corresponds to a first log data representing contents of operations performed on the client,
wherein the client comprises: a sender configured to:
i) generate a second log data representing contents of operations performed on the client;
ii) send the second log data to a file storage connected to the client via a network;
iii) generate a second index data corresponding to the second log data based on the second log data; and
iv) send the second index data to the server.

2. The system of claim 1, wherein the server further comprises:
a merging module configured to merge the second index data with the first index data.

3. The system of claim 1, wherein the client further comprises:
a management console, wherein the server generates search temporary result information based on search conditions that are input through the management console, and sends the search temporary result information to the client.

4. The system of claim 3, wherein the client searches the second log data stored in the file storage based on the search temporary result information.

5. The system of claim 1, wherein the operations performed on the client include at least one operation selected from operations of a logon, an application operation, a window title, a file operation, a main transmission printing, a device operation, and a web access.

6. The system of claim 1, wherein each of the first index data and the second index data includes a character included in the second log data, and an identifier of the second log data, wherein the identifier includes the character.

7. A client managing method in a system including a server and a client connected to the server via the Internet, the method comprising:
generating a policy data for the client by the server;
storing the policy data in the server;
delivering the policy data from the server to the client;
storing a first index data in the server, wherein the first index data corresponds to a first log data representing contents of operations performed on the client; and
generating a second log data representing contents of operations performed on the client, by the client;
sending the second log data from the client to a file storage connected to the client via a network;
generating a second index data corresponding to the second log data based on the second log data, by the client; and
sending the second index data to the server.

8. The method of claim 7, further comprising:
merging the second index data with the first index data.

9. The method of claim 7, further comprising:
generating search temporary result information based on search conditions that are input through a management console in the client; and
sending the search temporary result information to the client.

10. The method of claim 9, further comprising:
searching the second log data stored in the file storage based on the search temporary result information.

11. The method of claim 7, wherein the operations performed on the client include at least one operation selected from operations of a logon, an application operation, a window title, a file operation, a main transmission printing, a device operation, and a web access.

12. The method of claim 7, wherein each of the first index data and the second index data includes a character included in the second log data, and an identifier of the second log data, wherein the identifier includes the character.

13. An information processing apparatus, comprising:
a receiver configured to receive policy data from an external apparatus; and
a sender configured to:
i) generate a log data representing contents of operations performed on the information processing apparatus;
ii) send the log data to a file storage connected to the information processing apparatus via a network;
iii) generate a index data corresponding to the log data, based on the log data; and
iv) send the index data to the external apparatus.
